(19) United States
(12) Patent Application Publication
(10) Pub. No.: US 2007/0268885 A1
(43) Pub. Date: Nov. 22, 2007

(54) Method and system for two stage forwarding information base

(75) Inventors: Barry Ford, Nepean (CA); Steve Benson, Kanata (CA); Bernard St-Denis, Ottawa (CA)

Correspondence Address: Alan M. Weisberg;CHRISTOPHER & WEISBERG, P.A., Suite 2040, 200 East Las Olas Boulevard, Fort Lauderdale, FL, 33301, US

(73) Assignee: Nortel Networks Ltd.

(21) Appl. No.: 11/435,261

(22) Filed: May 16, 2006

(51) Int. Cl. H04L 12/28

(52) U.S. Cl. 370/351; 370/392; 370/428

(57) ABSTRACT

A method and system for data packet forwarding is provided. A forwarding information base is stored. The forwarding information base has a first stage with a first lookup key and a second stage with a second lookup key. The first lookup key is a portion of the second lookup key. The first stage is evaluated using the first lookup key forwarding the data packet is forwarded if the first stage evaluation yields a forwarding result. If the first stage evaluation does not yield a forwarding result, the second stage is evaluated using the second lookup key to determine a forwarding result. Such a method and system are suitable for use, among other places, in a network processing unit (“NPU”) in an IPv6 network.

### FIELD OF THE INVENTION

The present invention relates to network communications, and in particular to a method and system for routing packets such as Internet Protocol v6 (“IPv6”) packets using a two stage forwarding information base.

### BACKGROUND OF THE INVENTION

The expansion of the use of the Internet Protocol, such as through the ever increasing growth of the Internet has put a strain on the amount of device addresses available. The popular Internet Protocol v4 (“IPv4”) addressing scheme provided 32 address bits, arranged as four 8-bit segments. A more recent addressing scheme, IPv6, enlarges the address size to 128 bits. While this increased size allows for a vast number of addressed devices and very large networks, the increased address size of IPv6 also puts a tremendous strain on routing devices that must do queries in the forwarding information base (“FIB”) at very fast traffic rates. The FIB is used to determine where to forward inbound packets.

Routing devices typically include network processing units (“NPUs”) which are designed to perform the forwarding function. NPUs include a hardware based “fast path” that uses a tree look-up structure to make packet forwarding decisions. For example, FIG. 1 shows an exemplary prior art system 10 which uses a single stage FIB 12 for packet forwarding decisions. As is shown, inbound IP packet 14 is processed is processed by FIB 12 and forwarded as outbound packet 16. Single stage FIB 12 includes a key 18 based on the routing domain, prefix length and destination address and a resultant forwarding action 20 which is determined based on the key. The NPU is programmed and stores and processes FIB 12 to implement the “fast path” forwarding arrangement.

Current NPUs operating in an IPv4 environment such as is shown in FIG. 1 can forward packets at rates of 2.5 Gigabits (Gb)/second and faster. However, as noted above, the key used as the basis of the lookup task in the FIB is typically a domain identifier plus the destination network address. The larger the key, the slower the look-up. As should be evident, a resultant key in the IPv4 environment is much smaller than it is in the IPv6 environment. As such, while current NPUs perform quite well in the IPv4 environment, these NPUs can not forward packets in IPv6 environments at the same rates relative to their IPv4 performance. In fact, the size of the destination address length in IPv6 may result in a slow down of packet forwarding using existing NPUs to the point where it may become an issue and create network performance problems.

Solutions for increasing the forwarding performance in IPv6 networks have been proposed. For example, from a hardware perspective, a physically new NPU can be created which is better suited to the IPv6 environment than current NPUs. However, this requires hardware redesign and creation, and may require replacement of deployed hardware (routers, switches, components, etc.) and is therefore very costly, time consuming and disruptive. In addition, creating an entirely new NPU for IPv6 results in over-engineering IPv4 forwarding. Because there are still a significant amount of IPv4 based-devices in use, the cost and disruption with no real benefit to the IPv4 forwarding performance do not make a hardware replacement solution practical.

Other solutions for supporting an IPv6 FIB include using existing NPUs but making more of the forwarding decisions using software external to the NPU. This solution places a burden on the general CPUs in the forwarding devices, thereby ultimately necessitating a change of hardware because the existing CPU will not be able to perform its other functions if it must also engage in substantial packet forward processing. As such, simply writing software for execution by the general purpose CPU in forwarding devices is not practical.

What is desired is an arrangement under which existing NPUs can be re-programmed to support IPv6 forwarding at rates of speed comparable to rates current achievable for IPv4 packets.

### SUMMARY OF THE INVENTION

The present invention advantageously provides a method and system for routing IPv6 packets. The system and method includes a two stage FIB arranged and managed in a manner such that a majority of forwarding decisions can be made using the first of the two stages. This arrangement minimizes processing and FIB management overhead. A result is that the present invention provides improved forwarding performance over known IPv6 forwarding implementations.

In accordance with one aspect, the present invention provides a method for data packet forwarding. A forwarding information base is stored. The forwarding information base has a first stage with a first lookup key and a second stage with a second lookup key. The first lookup key is a portion of the second lookup key. The first stage is evaluated using the first lookup key and the data packet is forwarded if the first stage evaluation yields a forwarding result. If the first stage evaluation does not yield a forwarding result, the second stage is evaluated using the second lookup key to determine a forwarding result.

In accordance with another aspect, the present invention provides a storage medium storing a computer program which when executed performs a data packet forwarding method in which a forwarding information base is stored. The forwarding information base has a first stage with a first lookup key and a second stage with a second lookup key. The first lookup key is a portion of the second lookup key. The first stage is evaluated using the first lookup key forwarding the data packet is forwarded if the first stage evaluation yields a forwarding result. If the first stage evaluation does not yield a forwarding result, the second stage is evaluated using the second lookup key to determine a forwarding result.

In accordance with still another aspect, the present invention provides a device for forwarding data packets in which the device has a storage unit and a processing unit. The storage unit stores a forwarding information base. The forwarding information base has a first stage with a first lookup key a second stage with a second lookup key. The first lookup key is a portion of the second lookup key. The processing unit evaluates the first stage using the first lookup key and forwards the data packet if the first stage evaluation yields a forwarding result. If the first stage evaluation does not yield a forwarding result, the second stage is evaluated using the second lookup key to determine a forwarding result.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a prior art IP packet forwarding system;

FIG. 2 is a block diagram of an IP packet forwarding system constructed in accordance with the principles of the present invention;

FIG. 3 is a block diagram of a two stage FIB constructed in accordance with the principles of the present invention;

FIG. 4 are exemplary two stage FIB tables constructed in accordance with the principles of the present invention;

FIG. 5 is a flow chart of a FIB route update and addition process of the present invention; and

FIG. 6 is a flow chart of a FIB route deletion process of the present invention.

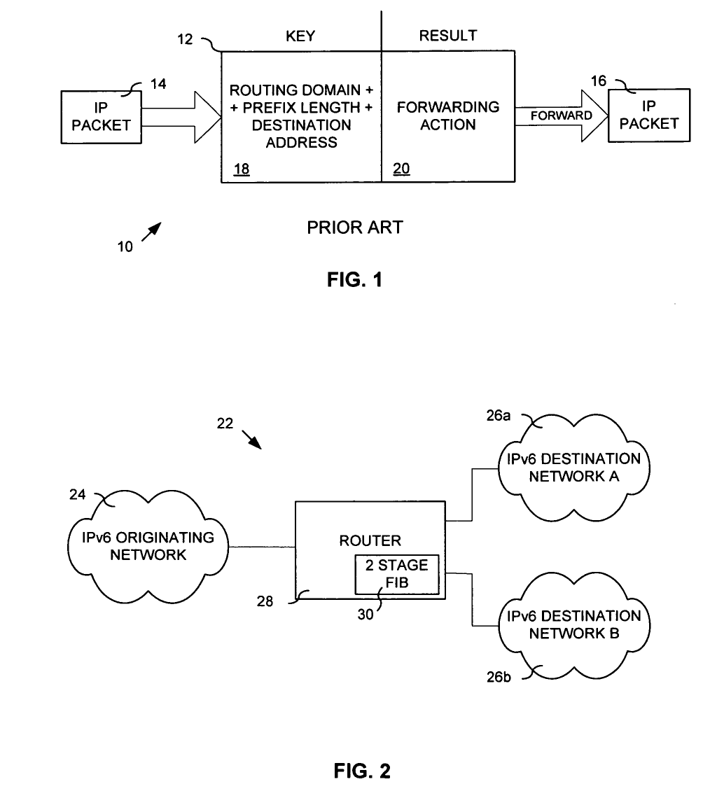

### DETAILED DESCRIPTION OF THE INVENTION

Referring now to the drawing figures in which like reference designators refer to like elements, there is shown in FIG. 2 a block diagram of a two stage IPv6 FIB management system constructed in accordance with the principles of the present invention and designated generally as “22”. System 22 includes IPv6 originating network 24, one or more IPv6 destination networks 26 (shown in FIG. 2 as IPv6 destination networks 26a and 26b) and router 28 having a two stage FIB 30. The two stage FIB 30, its use and management are described in detail below.

The hardware of router 28 can be any hardware suitable for implementing the present invention, and may include volatile and non-volatile storage devices, a central processing unit, input/output devices for management and configuration, network interface units for coupling router 28 to network communication lines and one or more NPUs. Two stage FIB 30 is typically part of an NPU although the present invention is not limited to such. Advantageously, two stage FIB 30 can be implemented programmatically within existing NPUs, thereby avoiding the need to replace hardware elements. These NPUs include volatile and/or non-volatile storage as well as processing units. These NPUs also include a hardware based “fast path” that can be used in accordance with the present invention to use a tree look-up structure to make packet forwarding decisions using the two stage FIB 30. In operation, a packet originating from IPv6 originating network 24 is received by router 28. Two stage FIB 30 contains forwarding information that includes instructions for how to forward inbound data packets to reach the destination address in a destination network 26.

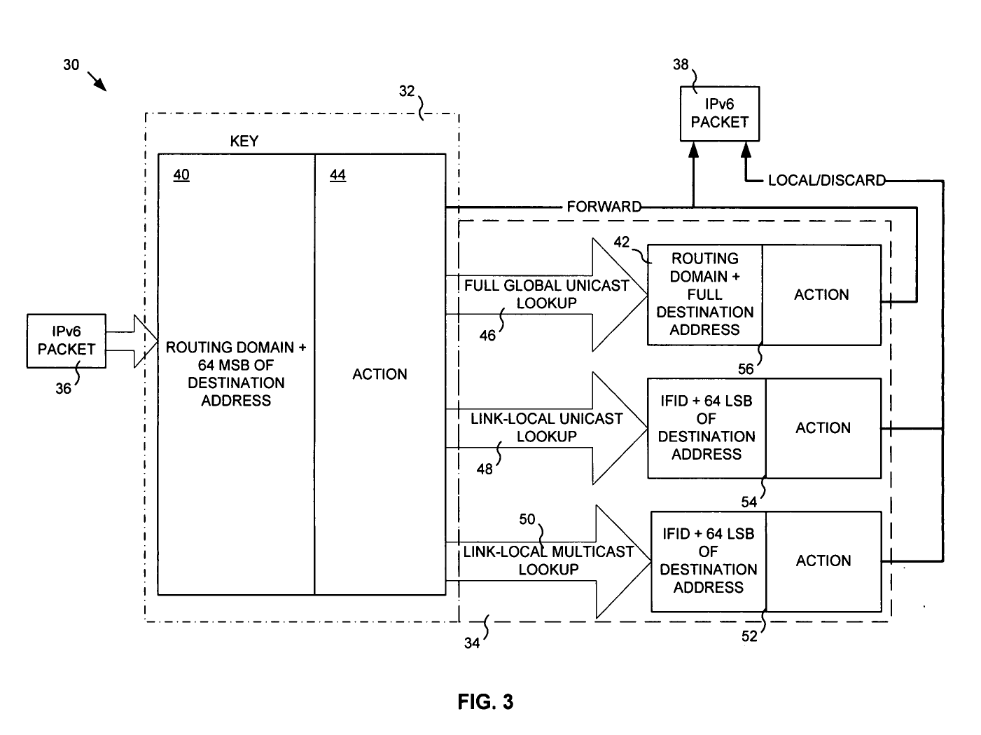

A two stage FIB constructed in accordance with the principles of the present invention is described with reference to FIG. 3. FIB 30 includes first stage 32 and second stage 34. IPv6 packet 36 is received by router 28, and the destination address contained in IPv6 packet 36 is evaluated to make a forwarding decision. That decision can result in the discard of IPv6 packet 36 or the forwarding of the packet locally or as outbound IPv6 packet 38. Two stage FIB 30 is arranged such that first stage 32 contains a portion of the key used within the second stage. For example, as is shown in FIG. 3, key 40 within first stage 32 is based on the routing domain, a route prefix length and the 64 most significant bits (“MSB”) of the destination address. In contrast, second stage 34 uses as its key 42 the routing domain, the route prefix length and the full 128 bit destination address. Such is the case for full global unicast lookup.

In operation, first stage 32 is used for lookup of the destination address. If the information in key 40 is sufficient to make a complete forwarding decision, e.g. forward the packet, discard the packet or locally terminate the packet, first stage action 44 is the forwarding action, resulting in the forwarding of outbound IPv6 packet 38. However, if lookup in first stage 32 fails to resolve the forwarding decision, lookup using second stage 42 is performed. This is the case for full global unicast lookup arrangements. In addition, other optional structures can be employed in the two-stage FIB 30 of the present invention, such as supporting link local unicast and link local multicast forwarding.

Because a predetermined number of most significant bits of the destination address are used in first stage key 40, this number can be selected so that most network address prefixes are covered under this predetermined quantity. For example, as shown in FIG. 3, first stage key 40 uses the 64 most significant bits of the destination address. It is contemplated that using the first 64 bits of the 128-bit address will allow the vast majority of forwarding decisions to be made using first stage 32.

Two stage FIB 30 is arranged so that forwarding decisions within each structure, for example, full global unicast structure 46, link-local unicast structure 48 and link-local multicast lookup structure 50 can be accomplished very quickly. Management processes, executed by a CPU in router 28 and described below in detail, can add, delete and update routes from two stage FIB 30 within those structures. In addition, as is discussed below, undesired iterations and copying of structures can be avoided by creating new structures to allow every search to be an exact match lookup, whether within the first stage 32 or second stage 34.

Of note, it is assumed that a hardware independent routing table is present within router 28. This routing database includes one entry per route using hardware independent data. For example, the hardware independent routing database includes the destination address, prefixed link, routing domain, and forwarding decision such as local versus remote versus discard.

Two stage FIB 30 includes first stage routes, second stage routes, lookup structures such as structures 46, 48 and 50, and management routes. First-stage routes include all routes present in first-stage FIB 42 and second-stage routes include all routes present in the global unicast second-stage FIB 44. Lookup structures 46, 48 and 50 provide a subset of routes from the first stage that need to be further described to affect an accurate routing decision. As noted above and as shown in FIG. 3, these lookup structures contain keys that are different than the first stage key 40. For example, full global unicast look-up structure 46 uses the routing domain, route prefix length and full destination address as its key 42, while link-local structures 48 and 50 use the interface ID (“IFID”) and 64 least significant bits of the destination address as their keys. Of note, it is presumed that link-local operation within IPv6 is known and is not described in detail herein. Rather, structures 48 and 50 are provided for the sake of completeness with full global unicast lookup structure 46 primarily being used as the mechanism for explaining the two stage operation of the present invention.

Management routes are not actual routes, for example link-local routes, but are implemented for the sake of completeness to provide a method for implementing a complete two stage FIB solution. Management routes are not provided by the IPv6 application. Fast lookup structures are subsets of the routes used for different searches.

As used herein the term “route pointer” refers to a pointer to the above-described hardware independent routing database. A route “key” includes the route pointer and routing domain, and represents one and only one route. The “fast lookup key” such as is used as key 40 in first stage 32 includes the routing domain and the first predetermined quantity of “x” of most significant bits of the destination address. The fast lookup key is also used for special cases such as when making a determination that there is a route that must be placed in second stage 34. This might happen, for example, when a determination is being made as to whether to move routes from first stage 42 to the second stage when routes are being added and/or deleted.

In accordance with the present invention, forwarding decisions can result in a value for normal forwarding such as a value for discard, forward, local, etc., or could have a value corresponding to a special management action such as a second stage global unicast lookup, second stage link-local unicast lookup or second-stage link-multicast lookup. Also, as is discussed below in more detail, the present invention employs shadow routes, and specifies shadow routes in second stage 34 and first stage 32. Shadow routes are routes that are needed in second stage 34 because of the presence of other related routes. For example, if there is a route having a “/48” prefix and the same routes are specified with a /128 prefix, a decision cannot be made from the destination address exactly which route is to be used. As such, a route must be placed in second stage 34 in order to make an accurate routing decision. Shadow routes can only have a prefix length less than the first stage key length with respect to the number of MSB of the destination address, e.g., 64 MSB of the destination address as shown in FIG. 3. The implementation of shadow routes advantageously allows a second stage which does not completely duplicate the first stage. In addition, although shadow routes can be actually added to second stage 34, these routes can also be implemented in first stage 32 using boolean logic to determine whether the route in first stage 40 is a shadow route.

With this framework in mind, the management structures described above are explained in detail. The entries in first stage 32 are used to represent the routes in first stage 32. As noted above, the key 40 is a route key. The result of a lookup in first stage 32, namely action 44, includes a forwarding decision as to what type of forwarding is to be undertaken, the determination of forwarding parameters such as what the NPU needs to know to forward the packet, such as what interface to use, and a shadow route status.

The second stage route structure is used to represent routes in second stage 34. The key used in second stage lookup is the route key which includes the routing domain and route pointer. The result of the second stage 34 lookup is a forwarding decision with corresponding forwarding parameters. Unlike first stage 32 lookups, second stage lookups do not result in the determination that the route is a shadow route.

Fast lookup structures are structures that are used to increase the speed of forwarding determinations. Three types of fast lookup structures are contemplated, namely, structures to facilitate the lookup of global unicast second stage routes, structures to facilitate the determination of global unicast second stage candidate routes and shadow candidate routes. With respect to global unicast second stage lookup routes, these are structures in which an entry contains the set of route keys representing all routes matching the predetermined number of most significant bits of a destination address in which there is a route representing the predetermined quantity of most significant bits, e.g. 64, with a resultant decision indicating that a global unicast second stage lookup is required for all packets matching the predetermined quantity of most significant bits. Of note, for ease of explanation, the present invention is described using 64 MSB as the predetermined quantity of most significant bits, it being understood that this value can be adjusted. Global unicast second stage lookup routes therefore list all keys for all routes that match the first 64 bits. Of note, a second stage lookup route can be moved to the first stage.

Global unicast second stage lookup candidate routes represent the 64 MSB of a destination address where there is at least one route that can be used or is being used to have resultant decision to do a global unicast second stage lookup. In such a case, the entry includes a route key representing either the second stage lookup or a key noting that the route key will be used for second stage lookup if needed in the future. Shadow candidate routes represent the 64 MSB of a destination address which has routes with a prefix length of less than 64 but matches the 64 MSB. Entries for shadow candidate routes include a set of route keys representing all shadow candidate routes.

Fast lookup structures use a key which includes the routing domain plus the 64 most significant bits of the destination address. The result of a lookup using this structure is a route key for a second stage lookup candidate or a set of route keys representing a list of routes associated with the first 64 bits of the destination address.

FIB management structures include management routes which can have structures used to represent management and/or default routes in FIB 30. The present invention contemplates five different types of management routes, namely, a no route default, link-local unicast management route, link-local multicast management route, an invalid route, and a non-link local multicast route. The no route default is represented as “::/0” which is used if no other matching route is found. This route is added to both first stage 32 and second stage 44 global FIBs. Route lookup which results in a no route default is redirected to software within router 28 for discard or an ICMP reply.

A link-local unicast management route can be specified with a particular prefix, for example, FE80::/10, which is hit for all link-local unicast destination addresses. Present in first stage FIB 42, a hit causes a redirect to the link-local second stage FIB for resolution. An example is shown as structure 52 in FIG. 3. Of note, a link-local unicast management route is present in first stage FIB 32 only.

A link-local multicast management route is also specified by a particular prefix, such as FF02::/16 which is hit during lookup for all link-local multicast destination addresses. Link-local multicast management route lookups are redirected to the link-local multicast second stage FIB for resolution. An exemplary structure is shown on FIG. 3 as link-local multicast lookup structure 50. As with a link-local unicast management route, a link-local multicast management route is provided in first stage FIB 32 only.

The invalid routes is specified as “::/128” which is established as the unspecified address for IPv6. Since it is illegal to have the unspecified address as the destination address, an entry is made in second stage FIB 34 only. Management routes are arranged so that if there is an entry in two stage FIB 30, a route is present.

As shown in FIG. 3, the resolution of a route using first stage FIB 32 results in the forwarding of the IPv6 packet (for global unicast packets). Of note, although the term “forward” is used herein, it is used in the general sense. It is understood that other actions, such as local termination or discard, can be taken with respect to a packet. If second stage lookup is required, full global unicast structure 46 processing results in a forwarding action. However, in the cases with link-local lookups, an actual forwarding decision is not necessary so the resultant decision is either that the packet is destined for a valid local address or should be discarded. With respect to link-local FIB management such as second stage 34 FIBs 52 and 54, it is contemplated that link-local unicast and multicast routes all have a prefix length of 128 bits because only 128 bit addresses are supported in a link-local environment. As such, the routes are either valid or not.

Accordingly, there is very little management needed for link-local routes. These routes are present according to the attributes of the interface and the state of the interface. Link-local routes are defined according to the IPv6 protocol or derived from the IPv6 addresses configured according to the IPv6 protocol. As noted above, forwarding decisions are limited. If a route is not present, the forwarding decision is to discard the packet. If the route is present, it is accepted as a local packet. For the sake of completeness and ease of aiding the following explanation, the portion of second stage FIB 34 that supports the full global unicast lookup structure 46 is referred to as global unicast FIB 56.

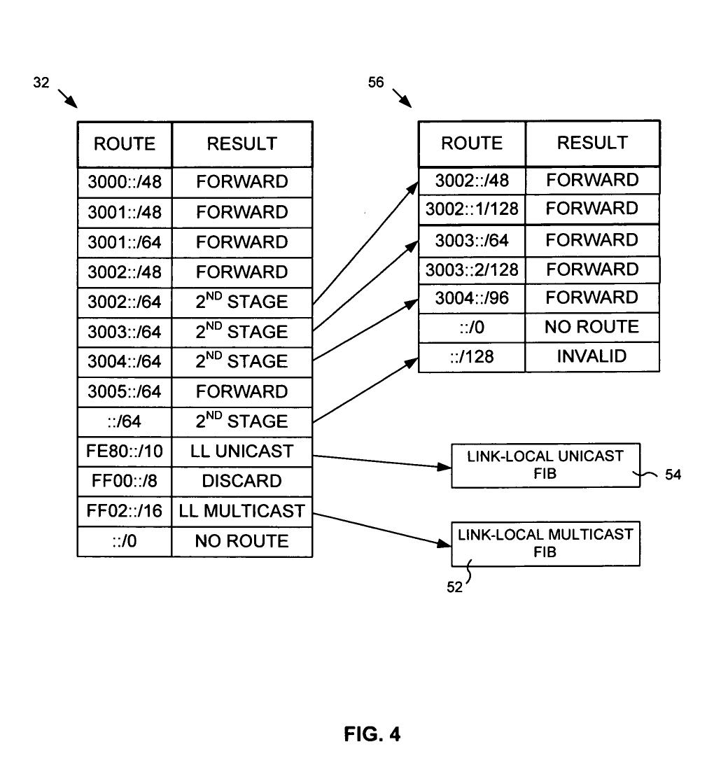

An exemplary use of the two stage FIB of the present invention is explained with reference to FIG. 4. FIG. 4 shows examples of representative entries that might be found in first stage FIB 32, and global unicast second stage FIB 56, link-local unicast second stage FIB 54 and link-local multicast FIB 52. As may be seen in FIG. 3, FIBs 52, 54 and 56 are structures within second stage FIB 34. Of note, for ease of understanding, the routing domain component of the key and route are omitted from the tables in FIG. 4.

First stage FIB 32 includes routes listed in IPv6 shorthand as well as the resultant activity if a route is matched. For example, the first entry in FIB 32 shows a route of “3000::/48”. This shorthand refers to routes beginning with the number 3000, the colons represent shorthand for zeroes, and the “/48” component refers to the prefix length. Accordingly, an inbound packet having a destination address of “3000::1” would best match the first entry in first stage FIB 32. Because a match is found, the resultant activity is to instruct the NPU to forward the packet. As such, packet forwarding can be determined quickly using first stage FIB 32. Similarly, a packet having a destination address of “3001::1” would match the third entry in FIB 32 with the resultant action being to forward the packet.

As another example, an inbound IPv6 packet 36 having a destination address of “3002::5” would result in a second stage lookup based on its best match of the fifth line of first stage FIB 32. As such, referring to second stage global unicast FIB 56, the first line of that table shows a best match with entry “3002::/48” with a resultant action of forwarding the data packet. As noted above, although the term “forward” is used herein, it is used in the general sense. It is understood that other actions, such as local termination or discard, can be taken with respect to a packet and a decision as to an action to be taken from query of first stage FIB 32 or second stage FIG. 56.

As still another example, a packet arriving with a destination address of “4000::1” would best match the “::/0” no route entry. With respect to link-local operation, a packet arriving with a destination address of “FE80::1” would best match the entry in the tenth line of first stage FIB 32. The packet would be considered a link-local unicast packet for local delivery and a lookup in second stage link-local unicast FIB 54 would result. Similarly, a packet having a destination address of “FF02::1” would best match the twelfth entry in first stage FIB 32 and would be considered a link-local multicast packet for local delivery, with lookup in link-local multicast FIB 52 being the second stage operation. However, a packet having a destination address of “FF01::1” would best match the eleventh line of first stage FIB 32 and would be discarded.

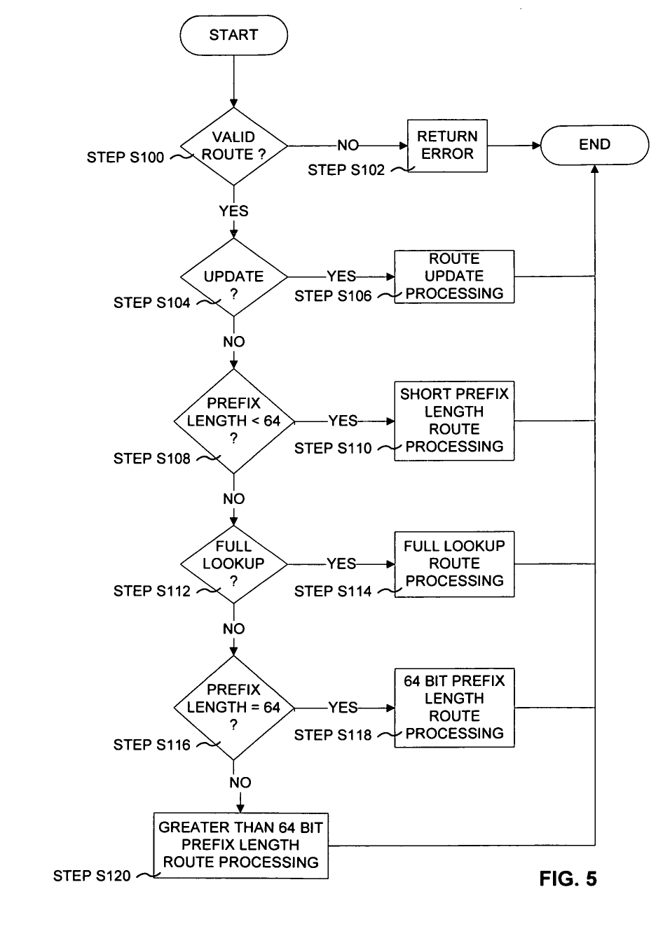

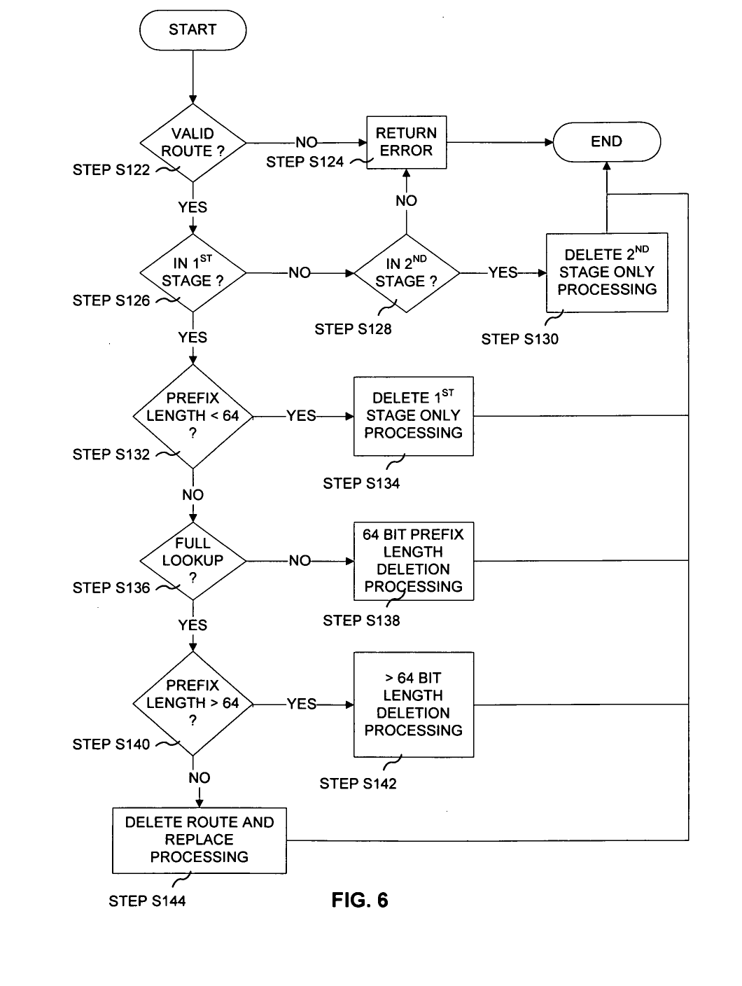

Operation of two stage FIB 30 involves the addition, deletion and updating of routes from the FIB. The processes for route addition, deletion and update are typically executed by a CPU within router 28. Once the appropriate changes have been calculated, FIB 30 is updated by CPU 28. The addition and deletion of management and link-local routes are the same as would be handled in IPv4 and are also operations that are specific to particular NPUs. It is presumed that one familiar with router programming and IPv4 operation can implement programmatic code to support management and link-local route addition and deletion and is therefore not discussed herein. However, the addition, deletion and updating of global unicast routes in connection with IPv6 two stage FIB operation is described herein with reference to FIGS. 5 and 6.

The processes of adding and updating routes within two stage FIB 30 are described with reference to FIG. 5. In general, the main route addition and update process of the present invention validates the route, then determines which sub-process to use depending on whether FIB 30 is to be updated, the route has a particular prefix length or whether the destination address matches a route pointing to the second stage global unicast FIB (FIB 56). Referring to FIG. 5, CPU 28 makes a determination as to whether the route is valid (step S100). If the route is not valid, an error is returned and error processing is performed (step S102). If the route exists but merely requires an update (step S104), route update processing is performed (step S106). If the route is not an update, i.e., it is not in two stage FIB 30, a determination is made as to whether the route has a prefix length less than 64 (step S108). If the route prefix length is less than 64, short prefix length route processing (step S110) is performed. If the prefix length is not less than 64, a determination is made as to whether the route is a full candidate lookup match (step S112). If the route is a full candidate lookup match, full lookup match processing is performed (step S114). If there is no full candidate lookup match, the route prefix is evaluated to determine whether the prefix length equals 64 (step S116). If the prefix length equals 64, 64 bit prefix length route processing is performed (step S118). If the prefix length does not equal 64, it is presumed that the prefix length must be greater than 64 bits, and greater than 64 bit prefix length processing is performed (step S120).

The update and route addition processing methods are described in detail. With respect to route update processing step S106, the route is evaluated so that it is only present in one of the two FIBs 32 and 56 unless this route is used as the full lookup route pointing to second stage FIB 56. If the route is in second stage 56, then it cannot be in first stage FIB 32 and appropriate action is taken. If it is a full lookup route, both first stage FIB 32 and second stage FIB 56 are updated.

With respect to the short prefix length route processing of step S110, the route is evaluated and only routes with a prefix of less than 64 are placed in the second stage if the route is a shadow route. Otherwise, the route is added to first stage FIB 32. If the route is a full lookup match, i.e. routes in the second stage that have the same 64 most significant bits of the destination address, then the route is added to second stage FIB 56.

Where the route prefix is greater than or equal to 64 and full lookup route processing of step S114 is required, the route is added to second stage FIB 56. There is a full candidate lookup match. Of note, a full candidate lookup represents a lookup in the global unicast second stage FIB 56 route structure, while a full lookup represents a lookup in the global unicast second stage FIB 56 lookup route structure. If there is no full lookup match, the full lookup route is added to first stage FIB 32. If there are existing shadow candidate routes, they are added to second stage FIB 56. If there is already a full lookup match, the corresponding route key is added to the full lookup entry set of route keys.

Where there is not already a full lookup candidate for this route and the prefix length is 64, 64 bit prefix length route processing of step S118 results in the addition of the route to first stage FIB 32 only. This is the case because there are no other routes with prefix lengths greater than or equal to 64 that match the first 64 MSB for this route. Where there is no full candidate lookup match (step S112) and the prefix length is greater than or equal to 64, because there is no other route where the prefix of greater than or equal to 64, the same 64 MSB of this route is added to second stage FIB 56 and a full lookup entry is added to first stage FIB 32. In addition, any shadow candidates are added to second stage FIB 56.

Route deletion is explained with reference to FIG. 6. With respect to route deletion in general, CPU 28 validates the routes and then determines what actions are needed to remove the target routes. Such determination may involve adjusting the entries in the first stage FIB 32 and second stage FIB 56 to ensure that performance and operability are maintained. Referring to FIG. 6, initially, the route being processed is validated (step S122). If the route is not valid, and error is returned and error processing performed (step S124). If the route is not in the first stage (step S126) and the route is not in the second stage (step S128), an error is returned and error processing performed (step S124). However, if the route is not in the first stage (step S126) but the route is in the second stage (step S128), delete second stage only processing is performed (step S130). For delete second stage only processing, such a route would have a prefix of greater than or equal to 64. The route is located in second stage FIB 56, if there is only one other route left with the prefix length of 64 in the full lookup entry structure, that remaining route is moved to the first stage FIB 32, i.e., it is also deleted from second stage FIB 56. However, if the prefix length is greater than 64, the route is simply deleted from second stage FIB 56.

If the route is in the first stage (step S126), the prefix length is checked to determine whether it is less than 64 (step S132). If it is, delete first stage only processing is performed (step S134). In this case, the route is removed from the first stage FIB 32, and if a shadow route exists, the shadow route is removed from second stage FIB 56.

If the route is in the first stage (step S126) and the prefix length is not less than 64, a determination is made as to whether there is a full lookup match in the first stage FIB 32. If there is not, then there is no route and 64 bit prefix length route deletion processing is performed (step S138). In this case, the route is removed from first stage FIB 32.

If there is a full lookup match in step S136, the prefix length is checked to determine whether it is greater than 64 bits (step S140). If such is the case, and there is no other route with the same 64 MSB of the destination address, there is no route, and greater than 64 bit prefix length route deletion processing is performed (step S1142). In this case since there is no other route with a prefix greater than or equal to 64 and the same 64 MSB of this route, the route is deleted from second stage FIB 56 so that the full lookup route is removed. Any shadow routes are deleted and all structures are cleared of entries for this route.

If the prefix length is not greater than 64 in step S140, and there is a full lookup match with other routes (step S136), then the route is deleted and replaced via delete route and replace processing (step S144). In this case, if there is only one other route left and its prefix length is 64, it is moved to first stage FIB 32 and replaces the full lookup route. Otherwise, the full lookup route is replaced with a different route from one of the other routes left from the full look-up match.

With respect to alternative implementation options, it is contemplated that link-local second stage structures 48 and 50 can be combined into a single structure. In this regard, the first 64 MSB of the link-local destination address need not be constant. However, this arrangement requires the IFID and 128 bit destination address lookup in second stage FIB 34.

The two stage FIB arrangement of the present invention allows customized forwarding according to real world situations. This is the case because the present invention takes advantage of prefix distributions for real IPv6 networks and allows adjustment for them between first stage FIB 32 and second stage FIB 34. In that regard, forwarding speed is increased for targeted lookups, in particular those that can be resolved by lookup in first stage FIB 32 and the packets forwarded there from. This arrangement increases the hardware forwarding rate, thereby allowing existing NPUs to be used, with the only modification being to the programmatic software code running the NPUs as well as the CPUs used to perform route add, delete and update processing. The present invention also prevents thrashing of FIB 30 because lookup performance is not degraded over time. This is the case because the method of the present invention allows routes to be updated and moved form first stage FIB to second stage FIB and vice versa, as necessary. The result is that the real time needed to manage the FIB is minimized as is the memory overhead required for FIB management and implementation.

The present invention can be realized in hardware, software, or a combination of hardware and software. An implementation of the method and system of the present invention can be realized in a centralized fashion in one computing system, or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system and/or components within the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A data packet forwarding method, the method comprising:
storing a forwarding information base, the forwarding information base having:
a first stage with a first lookup key; and
a second stage with a second lookup key, the first lookup key being a portion of the second lookup key;
evaluating the first stage using the first lookup key and forwarding the data packet if the first stage evaluation yields a forwarding result; and
if the first stage evaluation does not yield a forwarding result, evaluating the second stage using the second lookup key to determine a forwarding result.

2. The method according to claim 1, wherein the data packet is an IPv6 data packet.

3. The method according to claim 2, wherein the first lookup key includes a predetermined portion of an IPv6 destination address and the second lookup key includes an entirety of an IPv6 destination address.

4. The method according to claim 3, wherein the predetermined portion is a 64 most significant bits.

5. The method according to claim 3, wherein the first and second keys further include a routing domain.

6. The method according to claim 1, wherein the second stage is comprised of a plurality of structures, at least one of the structures being a link-local routing structure.

7. The method according to claim 1, further comprising:
evaluating the entries in the first and second stage forwarding information bases for one of a route addition, route update and route deletion; and
adjusting route entries in the first and second stage forwarding information bases based on the one of the route addition, route update and route deletion.

8. A storage medium storing a computer program which when executed performs a data packet forwarding method, the method comprising:
storing a forwarding information base, the forwarding information base having:
a first stage with a first lookup key; and
a second stage with a second lookup key, the first lookup key being a portion of the second lookup key;
evaluating the first stage using the first lookup key and forwarding the data packet if the first stage evaluation yields a forwarding result; and
if the first stage evaluation does not yield a forwarding result, evaluating the second stage using the second lookup key to determine a forwarding result.

9. The method according to claim 8, wherein the data packet is an IPv6 data packet.

10. The method according to claim 9, wherein the first lookup key includes a predetermined portion of an IPv6 destination address and the second lookup key includes an entirety of an IPv6 destination address.

11. The method according to claim 10, wherein the predetermined portion is a 64 most significant bits.

12. The method according to claim 10, wherein the first and second keys further include a routing domain.

13. The method according to claim 8, wherein the second stage is comprised of a plurality of structures, at least one of the structures being a link-local routing structure.

14. A device for forwarding data packets, the device comprising:
a storage unit, the storage unit storing a forwarding information base, the forwarding information base having:
a first stage with a first lookup key; and
a second stage with a second lookup key, the first lookup key being a portion of the second lookup key;
a processing unit, the processing unit:
evaluating the first stage using the first lookup key and forwarding the data packet if the first stage evaluation yields a forwarding result; and
if the first stage evaluation does not yield a forwarding result, evaluating the second stage using the second lookup key to determine a forwarding result.

15. The device according to claim 14, wherein the data packet is an IPv6 data packet.

16. The device according to claim 15, wherein the first lookup key includes a predetermined portion of an IPv6 destination address and the second lookup key includes an entirety of an IPv6 destination address.

17. The device according to claim 16, wherein the predetermined portion is a 64 most significant bits.

18. The device according to claim 14, wherein the device is an NPU and the first stage evaluation is a part of a fast path processing.

19. The device according to claim 14, wherein the second stage is comprised of a plurality of structures, at least one of the structures being a link-local routing structure.

20. The device according to claim 14, wherein, based on an evaluation of the entries in the first and second stage forwarding information bases for one of a route addition, route update and route deletion, route entries in the storage unit for the first and second stage forwarding information bases are changed based on the one of the route addition, route update and route deletion.
